(19) United States
(12) Patent Application Publication
(10) Pub. No.: US 2026/0246670 A1
(43) Pub. Date: Aug. 20, 2026

(54) SYSTEM INCLUDING CODING DEVICE FOR TRANSCEIVING MULTI-LEVEL SIGNAL

(71) Applicant: Seoul National University R&DB Foundation, Seoul (KR)

(72) Inventors: Giyeong HEO, Seoul (KR); Suhwan KIM, Seoul (KR)

(73) Assignee: Seoul National University R&DB Foundation, Seoul (KR)

(21) Appl. No.: 19/196,435

(22) Filed: May 1, 2025

(30) Foreign Application Priority Data
Feb. 20, 2025 (KR) 10-2025-0022179

(51) Int. Cl. H04L 25/49; H04B 14/02; H04L 1/00

(52) U.S. Cl. CPC H04L 25/4917; H04B 14/023; H04L 1/0042

(57) ABSTRACT

A system includes an encoder configured to generate a flag symbol and a plurality of codeword symbols by encoding a plurality of symbols; and a transmitter configured to convert each of the flag symbol and the plurality of codeword symbols into a multi-level signal having one of a first level, a second level, a third level, and a fourth level in ascending order of voltage magnitude and transmit the multi-level signal through a channel, wherein the encoder includes a first circuit configured to encode an even numbered symbol among the plurality of symbols into a codeword symbol having the second level or the third level when the even numbered symbol has the first level or the fourth level and set the flag symbol to indicate whether the even numbered symbol is modified.

### STATEMENT REGARDING SUPPORTED GRANT

The present disclosure was supported by the Institute of Information and Communications Technology Planning and Evaluation (IITP) grant funded by the Ministry of Science and ICT (MSIT) under Grant 2022-0-01013.

### CROSS-REFERENCE TO RELATED APPLICATION

The present application claims priority under 35 U.S.C. § 119 (a) to Korean Patent Application No. 10-2025-0022179, filed in the Korean Intellectual Property Office on Feb. 20, 2025, which application is incorporated herein by reference in its entirety.

### BACKGROUND

### 1. Technical Field

Embodiments generally relate to a system including a coding device and transceiving a multi-level signal.

### 2. Related Art

Pulse-Amplitude Modulation 4 (PAM4) signaling can achieve twice the data transmission rate per pin when using a clock signal of the same speed compared to the existing Non Return to Zero (NRZ) signaling by modulating a signal into one of four voltage levels.

However, there is a disadvantage that noise sensitivity increases because the voltage difference between adjacent PAM4 levels is reduced to ⅓ compared to NRZ signal having the same output swing.

Maximum Transition Avoidance (MTA) coding is a data coding technique that aims to improve signal quality in terms of inter-symbol interference (ISI) and crosstalk by removing maximum amplitude transitions such as a transition between “00” and “11” among PAM4 signals.

In the EYE diagram describing PAM4 signal transmission, there are three eyes including an upper eye, a middle eye, and a lower eye. If MTA coding is not applied, the sizes of the upper and lower eyes become relatively small, and if MTA coding is applied, the size of the middle eye becomes relatively small.

Most existing MTA coding methods are LUT-based 7b/8b MTA coding. In the 7b/8b MTA coding, 1-bit data is separated from 8-bit data transmitted on each data line and a plurality of 1-bit data separated from a plurality of 8-bit data are gathered and are transmitted via a Data Bus Inversion (DBI) pin existing in the conventional memory interface, and the remaining 7-bit data is encoded into an 8-bit data with no maximum amplitude transition referring to the LUT.

This can improve the signal quality from the perspective of ISI and crosstalk, but there is no improvement from the perspective of power noise, and rather, there is a problem that the power noise characteristics deteriorate because the original DBI function, which is introduced to reduce power noise by reducing the existing load current variation, cannot be used.

### SUMMARY

In accordance with an embodiment of the present disclosure, a system may include an encoder configured to generate a flag symbol and a plurality of codeword symbols by encoding a plurality of symbols; and a transmitter configured to convert each of the flag symbol and the plurality of codeword symbols into a multi-level signal having one of a first level, a second level, a third level, and a fourth level in ascending order of voltage magnitude and transmit the multi-level signal through a channel, wherein the encoder includes a first circuit configured to encode an even numbered symbol among the plurality of symbols into a codeword symbol having the second level or the third level when the even numbered symbol has the first level or the fourth level and set the flag symbol to indicate whether the even numbered symbol is modified.

In accordance with an embodiment of the present disclosure, a system may include a receiver configured to receive a multi-level signal having one of a first level, a second level, a third level, and a fourth level in ascending order of voltage magnitude from a channel and convert the multi-level signal into a flag symbol and a plurality of codeword symbols; and a decoder configured to generate a plurality of symbols from the flag symbol and the plurality of codeword symbols, wherein the decoder includes a third circuit configured to decode an even numbered codeword symbol among the plurality of codeword symbols into a symbol having the first level or the fourth level when the even numbered codeword symbol has the second level or the third level and the flag symbol indicates that the even numbered codeword symbol is modified.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and advantages of those embodiments.

FIG. 1 illustrates a system according to an embodiment of the present disclosure.

FIGS. 2A and 2B illustrate a coding method according to an embodiment of the present disclosure.

FIG. 3 illustrates an encoder and a decoder according to an embodiment of the present disclosure.

FIG. 4 is a graph showing an effect of a system according to an embodiment of the present disclosure.

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to presented embodiments within the scope of teachings of the present disclosure. The detailed description is not meant to limit this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

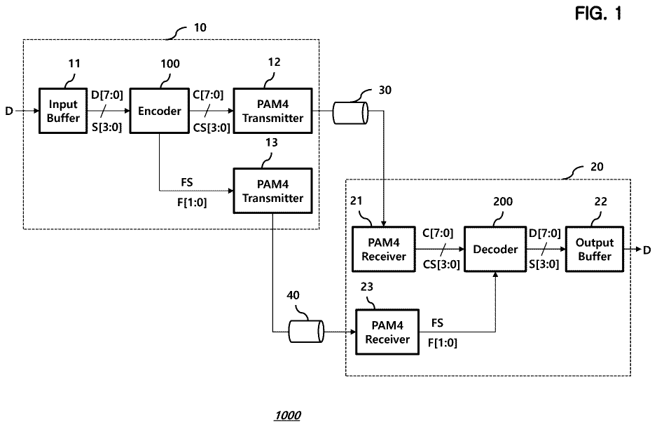

FIG. 1 is a block diagram showing a transceiving system 1000 according to one embodiment of the present disclosure. Hereinafter, the transceiving system 1000 may be simply referred to as a system 1000.

The system 1000 includes a transmitting device 10 and a receiving device 20.

The transmitting device 10 drives a data channel 30 to transmit a Pulse-Amplitude Modulation 4 (PAM4) signal, and the receiving device 20 receives the PAM4 signal transmitted through the data channel 30.

Though only one data channel 30 is shown in FIG. 1, the number of data channels may vary depending on embodiments.

The transmitting device 10 includes an input buffer 11, an encoder 100, and a PAM4 transmitter 12.

In this embodiment, the input buffer 11 stores data D input serially and outputs 8-bit data.

In this embodiment, data stored in the input buffer 11 and output therefrom is represented as D[7:0], and data D input earlier is stored as an upper bit in the input buffer 11.

In the present embodiment, 2-bit data forms one symbol S, and accordingly, 8-bit data stored in the input buffer 11 corresponds to four symbols.

A first symbol or symbol #0 S0 corresponds to D[7:6], a second symbol or symbol #1 S1 corresponds to D[5:4], a third symbol or symbol #2 S2 corresponds to D[3:2], and a fourth symbol or symbol #3 S3 corresponds to D[1:0].

The format of data input to the input buffer 11 may be changed in various ways depending on the embodiment. In another embodiment, data input to the input buffer 11 may be in units of 16 bits or 32 bits, and in this case, the input buffer 11 may provide data to the encoder 100 in units of 8 bits.

The encoder 100 encodes four symbols provided from the input buffer 11 to generate a plurality of codeword symbols CS. Data corresponding to the codeword symbol CS is indicated as a codeword C.

The encoder 100 can generate a flag symbol FS required for the decoding process, and data corresponding to the flag symbol FS can be indicated as a flag F.

The PAM4 transmitter 12 sequentially generates a PAM4 signal corresponding to a plurality of codeword symbols provided from the encoder 100 to drive the channel 30.

Hereinafter, a PAM4 signal can be indicated as a multi-level signal, and the multi-level signal corresponds to one of a first level, a second level, a third level, and a fourth level in ascending order of voltage magnitude.

In this embodiment, it is assumed that each of a symbol, a codeword symbol, and a flag symbol is a 2-bit signal, and the relationship between each symbol and each level is as shown in Table 1 below. This relationship can be changed to have different rules depending on embodiments.

TABLE 1

| Symbol, Codeword | A level of a |
|---|---|
| Symbol, Flag Symbol | multi-level signal |
| “00” | the first level |
| “01” | the second level |
| “10” | the third level |
| “11” | the fourth level |

In this embodiment, an 8-bit data is encoded into an 8-bit codeword and a 2-bit flag.

The flag symbol FS may be transmitted through a separate channel or a flag channel.

In this embodiment, a flag symbol FS is neither encoded nor decoded.

In this embodiment, it is assumed that the flag symbol FS is transmitted through a separate flag channel 40 different from the data channel 30, and for this purpose, the transmitting device 10 further includes a PAM4 transmitter 13 that generates a PAM4 signal from the flag symbol FS and drives the flag channel 40.

For example, when the transceiving system 1000 is used in a memory system, the transceiving system 1000 may use a data bus inversion (DBI) channel used for the DBI function as the flag channel 40.

At this time, the data channel 30 of FIG. 1 illustrates one of the four data channels, and the DBI channel may be used as the flag channel 40 that transmits the flag symbol FS.

The receiving device 20 includes a PAM4 receiver 21, a decoder 200, and an output buffer 22.

The PAM4 receiver 21 receives a PAM4 signal transmitted from the data channel 30 and outputs a plurality of codeword symbols CS.

In the present embodiment, the receiving device 20 further includes a PAM4 receiver 23 that receives a PAM4 signal transmitted from the flag channel 40 and outputs a flag symbol FS.

The decoder 200 decodes a codeword C[7:0] provided from the PAM4 receiver 21 and outputs corresponding data D[7:0].

The output buffer 22 stores 8-bit data D[7:0] output from the decoder 200 and outputs data D in serial.

In another embodiment, the output buffer 22 can buffer data output from the decoder 200 and output data in 16-bit or 32-bit units.

In FIG. 1, the input buffer 11, PAM4 transmitters 12 and 13, PAM4 receivers 21 and 23, and the output buffer 22 are well-known technologies in the related art, so specific disclosure thereof is omitted.

Hereinafter, the operation and configuration of the encoder 100 and decoder 200 are specifically disclosed.

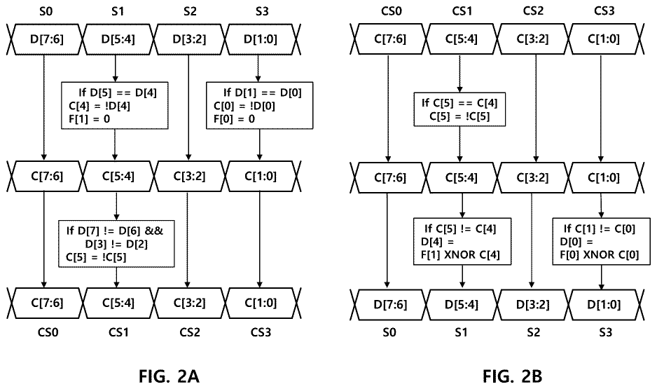

FIGS. 2A and 2B are diagrams explaining coding operations according to an embodiment of the present disclosure.

FIG. 2A corresponds to the encoding operation, and FIG. 2B corresponds to the decoding operation.

As aforementioned, the encoding and decoding operations according to an embodiment of the present disclosure are performed in units of 8-bit data.

In addition, in this embodiment, data stored in the input buffer 11 is indicated as D[7:0], and data input earlier is stored as an upper bit.

First, the encoding operation is disclosed. The encoding operation includes a first stage encoding operation and a second stage encoding operation.

The first stage encoding operation is performed on the even numbered symbols, that is, the second symbol S1 and the fourth symbol S3.

If two bits of the second symbol S1 are the same, one of the two bits is inverted and a flag bit corresponding thereto is set. In this embodiment, one of the two bits is the lower bit, and the flag bit is set to the low level.

Specifically, if the upper bit D[5] and the lower bit #4 D[4] of the second symbol S1 are the same, the lower bit D[4] of the second symbol S1 is inverted and used as the lower bit C[4] of the second codeword symbol CS1, and the upper bit F[1] of the flag F is set to 0.

Since the encoding operation for the fourth symbol S3 is the same as the encoding operation for the second symbol S1, repeated disclosure is omitted. The lower bit F[0] of the flag F is set to 0 or 1 according to a result of the encoding of the fourth symbol S3.

In this embodiment, as a result of the first stage encoding operation, the second codeword symbol CS1 and the fourth encoding symbol CS3 have the values of “01” or “10”, respectively.

Accordingly, the PAM4 signal transmitted through the channel does not have the maximum transition between “00” and “11”.

Next, the second stage encoding operation is described.

In the second stage encoding operation, in the present disclosure, if two bits of the first codeword symbol CS0 are different and two bits of the third codeword symbol CS2 are different, the remaining one bit of the two bits of the second codeword symbol CS1 is inverted. In this embodiment, the remaining one bit is the upper bit.

For example, if the first, second, and third codeword symbols are “01 10 10” as a result of performing the first stage encoding operation, the first, second, and third codeword symbols are changed to “01 00 10” after the second stage encoding operation is performed.

In this way, the second stage encoding operation can increase the number of transitions of the PAM4 signal, thereby improving resistance to power noise. Accordingly, the second stage encoding operation can be omitted under conditions where the influence of power noise is negligent.

Next, a decoding method is disclosed. The decoding operation includes a first stage decoding operation and a second stage decoding operation.

The first stage decoding operation corresponds to the second stage encoding operation, and the second stage decoding operation corresponds to the first stage encoding operation. If the second stage encoding operation is omitted, the first stage decoding operation can be omitted.

First, if the first stage encoding operation is performed, the codeword symbol #1 or the second codeword symbol CS1 has a value of “01” or “10”.

Accordingly, if the second stage encoding operation is performed and the value of the second codeword symbol CS1 is “11” or “00”, the second codeword symbol CS1 should be regarded as having been modified after the second stage encoding operation.

Therefore, if the two bits corresponding to the second codeword symbol CS1 are the same during the first stage decoding operation, the remaining bit of the two bits, i.e., the upper bit, is inverted.

Thereafter, the second stage decoding operation is performed.

As aforementioned, the codeword symbols changed through the first stage encoding operation are even numbered symbols, that is the second and fourth codeword symbols CS1 and CS3.

The first and third symbols S0 and S2 have the same values as the first and third codeword symbols CS0 and CS2.

As aforementioned, as a result of the first stage encoding operation, the second codeword symbol CS1 has a value of “01” or “10”, and if the upper bit F[1] of the flag F is 0, it indicates that one of the two bits of the second codeword symbol CS1, i.e., the lower bit, is inverted.

Accordingly, if the upper bit C[5] and the lower bit C[4] of the second codeword symbol CS1 are different, the lower bit D[4] of the second symbol S1 is set to the result of the XNOR operation on the lower bit C[4] of the second codeword symbol CS1 and the upper bit F[1] of the flag F.

Similarly, if the upper bit C[1] and the lower bit C[0] of the fourth codeword symbol CS3 are different, the lower bit D[0] of the fourth symbol S3 is set to the result of the XNOR operation on the lower bit C[0] of the fourth codeword symbol CS3 and the lower bit F[0] of the flag F.

The above disclosure assumes that the lower bits of the second symbol S1 and the fourth symbol S3 are inverted in the first stage encoding operation, the upper bit of the second symbol is inverted in the second stage encoding operation, and the decoding operation is performed accordingly.

However, an embodiment in which the upper bits of the second symbol S1 and the fourth symbol S3 are inverted in the first stage encoding operation, and the lower bit of the second symbol S1 is inverted in the second stage encoding operation is also possible. Since this can be easily understood by a person skilled in the art from the above disclosure, a repeated disclosure is omitted.

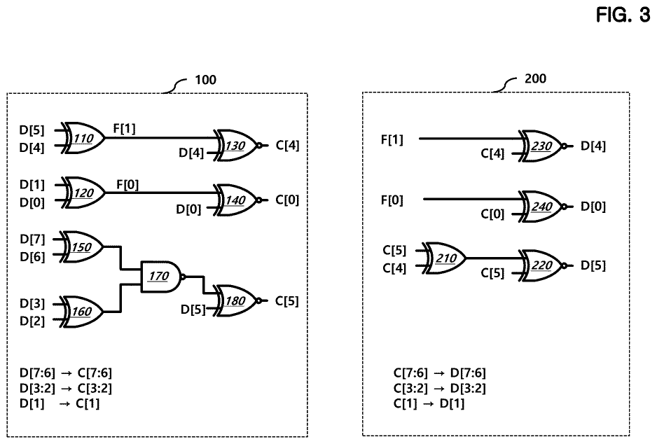

FIG. 3 is a logic circuit diagram showing the encoder and decoder according to an embodiment of the present disclosure.

The logic circuit diagram of the encoder 100 and the decoder 200 configures the encoding and decoding operations described in FIGS. 2A and 2B as gate-level logic circuits.

First, the configuration of the encoder 100 is disclosed.

The encoder 100 bypasses the first symbol S0 and the third symbol S2 as the first codeword symbol CS0 and the third codeword symbol CS2, and bypasses the upper bit D[1] of the fourth symbol S3 as the upper bit C[1] of the fourth codeword symbol CS3.

First, the circuit required for the first stage encoding operation is disclosed. Hereinafter, this may be referred to as the first circuit.

The encoder 100 includes an XOR gate 110 that performs an XOR operations on two bits D[5:4] of the second symbol S1 to generate the upper bit F[1] of the flag F, and an XOR gate 120 that performs an XOR operations on two bits D[1:0] of the fourth symbol S3 to generate the lower bit F[0] of the flag F.

The encoder 100 includes an XNOR gate 130 that performs an XNOR operations on the upper bit F[1] of the flag F and the lower bit D[4] of the second symbol S1 to generate the lower bit C[4] of the fourth codeword symbol CS3, and an XNOR gate 140 that performs an XNOR operations on the lower bit F[0] of the flag F and the lower bit D[0] of the fourth symbol S3 to generate the lower bit C[0] of the fourth codeword symbol CS.

Next, a circuit required for the second stage encoding operation is disclosed. Hereinafter, this may be referred to as the second circuit.

The encoder 100 includes an XOR gate 150 that performs an XOR operation on two bits D[7:6] of the first symbol S0, an XOR gate 160 that performs an XOR operation on two bits D[3:2] of the third symbol S2, a NAND gate 170 that performs a NAND operation on outputs of the XOR gates 150 and 160, and an XNOR gate 180 that performs an XNOR operation on the output of the NAND gate 170 and the upper bit D[5] of the second symbol S1 to output the upper bit C[5] of the second codeword symbol CS1.

If the second stage encoding operation is omitted, the encoder 100 may not include the second circuit required for the second stage encoding operation, and the encoder 100 bypasses the upper bit D[5] of the second symbol S1 as the upper bit C[5] of the second codeword symbol CS1.

Next, the configuration of the decoder 200 is disclosed.

The decoder 200 bypasses the first codeword symbol CS0 and the third codeword symbol CS2 to the first symbol S0 and the third symbol S2, and bypasses the upper bit C[1] of the fourth codeword symbol CS3 to the upper bit D[1] of the fourth symbol S3.

First, the circuit required for the first stage decoding operation is disclosed.

The decoder 200 includes an XOR gate 210 that performs an XOR operations on the two bits C[5:4] of the second codeword symbol CS1, and an XNOR gate 220 that performs an XNOR operations on an output of the XOR gate 210 and the upper bit C[5] of the second codeword symbol CS1 to output the upper bit D[5] of the second symbol S1.

If the second stage encoding operation is omitted, the decoder 200 may not include the circuit required for the first stage decoding operation, and the decoder 200 bypasses the upper bit C[5] of the second codeword symbol CS1 as the upper bit D[5] of the second symbol S1.

Next, the circuit required for the second stage decoding operation is disclosed.

The decoder 100 includes an XNOR gate 230 that performs an XNOR operation on the upper bit F[1] of the flag F and the lower bit C[4] of the second codeword symbol CS1 to generate the lower bit D[4] of the fourth symbol S3, and an XNOR gate 240 that performs an XNOR operation on the lower bit F[0] of the flag F and the lower bit C[0] of the fourth codeword symbol CS3 to generate the lower bit D[0] of the fourth symbol S3.

Hereinafter, the circuit required for the second stage decoding operation may be referred to as a third circuit, and the circuit required for the first stage decoding operation may be referred to as a fourth circuit.

In this way, the present embodiment performs encoding and decoding operations using a simple logic circuit, thereby minimizing the increase in latency required for encoding and decoding operations, thereby enabling high-speed operation.

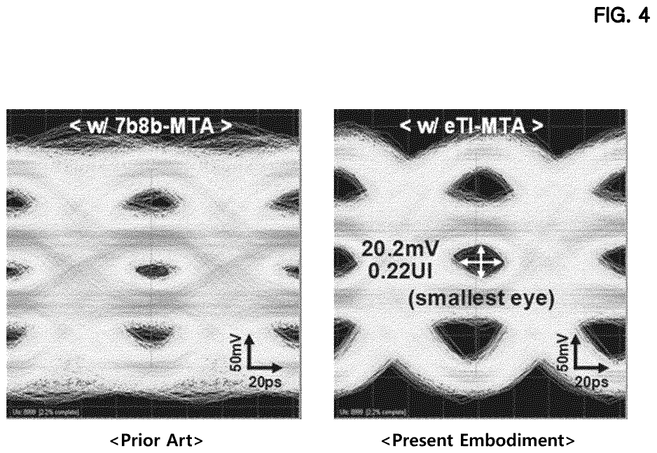

FIG. 4 is a graph showing the effect of the present embodiment.

The left diagram shows an eye diagram of a PAM4 signal when encoding is performed using a conventional technique, and the measurement results are described in Table 2.

The right diagram shows an eye diagram of a PAM4 signal when encoding is performed using the present technique, and the measurement results are described in Table 3.

Each eye diagram includes an upper eye, a middle eye, and a lower eye.

TABLE 2

| EYE | Upper Eye | Middle Eye | Lower Eye |
|---|---|---|---|
| Height (mV) | Closed | Closed | Closed |
| Width (ps) | | | |
| Width (UI) | | | |

TABLE 3

| EYE | Upper Eye | Middle Eye | Lower Eye |
|---|---|---|---|
| Height (mV) | 23.0 | 20.2 | 30.1 |
| Width (ps) | 22.2 | 18.4 | 25.3 |
| Width (UI) | 0.27 | 0.22 | 0.30 |

As shown in Table 2, in the prior art, all three eyes were indicated as closed because the height and width thereof are too small to measure, but in the present embodiment, as shown in Table 3, the eyes are expanded compared to the prior art.

As aforementioned, the present embodiment implements a simple coding circuit for PAM4 signal transmission based on a gate level logic circuit, thereby improving ISI and power noise while minimizing latency increase.

The present embodiment can achieve additional ISI reduction and power noise improvement through data coding itself without an additional compensation circuit required in the conventional LUT-based 7b/8b MTA coding.

Although various embodiments have been illustrated and described, various changes and modifications may be made to the described embodiments without departing from the spirit and scope of the disclosure as defined by the following claims.

What is claimed is:

1. A system comprising:
an encoder configured to generate a flag symbol and a plurality of codeword symbols by encoding a plurality of symbols; and
a transmitter configured to convert each of the flag symbol and the plurality of codeword symbols into a multi-level signal having one of a first level, a second level, a third level, and a fourth level in ascending order of voltage magnitude and transmit the multi-level signal through a channel,
wherein the encoder includes a first circuit configured to encode an even numbered symbol among the plurality of symbols into a codeword symbol having the second level or the third level when the even numbered symbol has the first level or the fourth level and to set the flag symbol to indicate whether the even numbered symbol is modified.

2. The system of claim 1, wherein the encoder further includes a second circuit configured to encode a second symbol among the plurality of symbols into a codeword symbol having the first level or the fourth level when the second symbol has the second level or the third level and both symbols adjacent to the second symbol have the second level or the third level.

3. The system of claim 2, wherein each of the plurality of symbols, the flag symbol, and the plurality of codeword symbols has 2 bits and a number of the plurality of symbols is 4.

4. A system comprising:
a receiver configured to receive a multi-level signal having one of a first level, a second level, a third level, and a fourth level in ascending order of voltage magnitude from a channel and convert the multi-level signal into a flag symbol and a plurality of codeword symbols; and
a decoder configured to generate a plurality of symbols from the flag symbol and the plurality of codeword symbols,
wherein the decoder includes a third circuit configured to decode an even numbered codeword symbol among the plurality of codeword symbols into a symbol having the first level or the fourth level when the even numbered codeword symbol has the second level or the third level and the flag symbol indicates that the even numbered codeword symbol is modified.

5. The system of claim 4, wherein the decoder further includes a fourth circuit configured to modify a second codeword symbol among the plurality of codeword symbols to have the second level or the third level when the second codeword symbol has the first level or the fourth level before the second codeword is provided to the third circuit.

6. The system of claim 5, wherein each of the plurality of symbols, the flag symbol, and the plurality of codeword symbols has 2 bits and a number of the plurality of symbols is 4.
